(19) United States
(12) Patent Application Publication
(10) Pub. No.: US 2008/0160352 A1
(43) Pub. Date: Jul. 3, 2008

(54) High Temperature Fuel Cell Having a Metallic Supporting Structure for the Solid Oxide Functional Layers

(75) Inventors: Marco Brandner, Hoefen (AT); Martin Bram, Juelich (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/963,301

(22) Filed: Dec. 21, 2007

Related U.S. Application Data
(63) Continuation of application No. PCT/EP2006/004926, filed on May 24, 2006.

(30) Foreign Application Priority Data
Jun. 22, 2005 (DE) 10 2005 028 797.2

(51) Int. Cl. H01M 8/02

(52) U.S. Cl. 429/12; 29/623.1; 29/623.5

(57) ABSTRACT

A high-temperature fuel cell having a metallic support structure, which has through openings for a gas, for the solid oxide functional layers, a fine-pored intermediate structure made of nickel or a nickel alloy being provided between the coarse-pored support structure and the functional layer facing toward it. The fine-pored intermediate structure is preferably formed by a mesh having a mesh width of a magnitude less than 80 μm, while the support structure is a perforated sheet or a perforated foil. A fuel cell may be produced where the fine-pored intermediate structure is welded to the coarse-pored support structure, and catalytically active anode material is then introduced into the pores of intermediate structure.

### CROSS REFERENCE TO RELATED APPLICATIONS

This application is a continuation of PCT International Application No. PCT/EP2006/004926 filed May 24, 2006 which claims priority under 35 U.S.C. § 119 to German Patent Application No. 10 2005 028 797.2 filed Jun. 22, 2005, the entire disclosures of which are expressly incorporated by reference herein.

### BACKGROUND AND SUMMARY OF THE INVENTION

The present invention relates to a high-temperature fuel cell having a metallic support structure (so-called substrate), which has through openings for a gas, for the solid oxide functional layers. Reference is made, for example, to DE 102 38 857 A1, the disclosure of which is hereby incorporated by reference, including the technical background.

In widely distributed high-temperature fuel cells (SOFC) for stationary use, the supporting function is assumed by one of the ceramic cell layers or functional layers (namely anode, electrolyte, or cathode) themselves. In contrast, the use of porous, metallic support structures is advantageous for the mobile employment of SOFC technology, because these layers have a higher mechanical and thermal shock resistance than ceramic layers. A metallic support structure, which may be implemented in light construction, is preferably used on the fuel gas side (anode) of the fuel cell.

In addition to sufficient stability for the support function, the metallic substrate must have the highest possible porosity and gas permeability, high electrical conductivity, low manufacturing tolerances, good ability to be coated in regard to the solid oxide functional layers to be applied, a thermal expansion coefficient tailored to these functional layers, and high long-term resistance. To fulfill all of these requirements as well as possible, ferritic Fe, Cr steels, which form chromium oxide, such as Crofer22APU, are used for the support structure.

The long-term stability of metallic support structures to corrosion is a function of their specific surface area. This results in a need to produce coarse structures having a low surface/volume ratio. Because of the favorable surface/volume ratio, the metal substrate is implemented, for example and/or preferably, in the form of a perforated sheet or a perforated foil, compare DE 102 38 857 A1 in this regard. Alternatively, the metallic support structure may also be formed by woven or knitted fabrics (compare, for example, EP 1 318 560 A2 and EP 1 328 030 A1) or by powder-metallurgy structures, which is also true for the support structure(s) of a fuel cell according to the present invention.

Substrates or support structures having large holes, pores, or also flaws caused by manufacturing have the disadvantage that it is more difficult to coat them flawlessly with solid oxide functional layers. In particular, holes or surface defects of this type may not be compensated for by the relatively thin functional layers (such as anode functional layers having a thickness less than 100 μm), without these defects previously having been closed in a complex way (see, for example, WO 2004/059765 A2). To be able to apply a flawless functional layer, the holes, pores, or flaws in the substrate surface should be smaller than the layer thickness of the anode. Otherwise, these flaws are transferred into the next functional layer, i.e., into the electrolyte layer of the next anode layer applied, and the function and gas tightness of this layer may not be ensured. These problems exist essentially independently of the particular coating technology by which the ceramic solid oxide functional layers are applied to the substrate or the support structure. According to the current prior art, these functional layers may be applied by thermal spraying methods or by wet-chemical technologies using subsequent sintering. Deposition of functional layers from the gas phase (PVD—physical vapor deposition) is also possible.

The use of a perforated sheet support structure may additionally also have a further disadvantage, namely with regard to the bonding to the applied functional layer. Thus, when perforated sheets are coated, absent additional measures, the mechanical fusing between the smooth sheet surface and the anode layer (for example) is not satisfactory. Shrinkage processes represent a further problem if the anode layer is applied by wet chemistry with subsequent sintering. The anode layer shrinks in the vertical, but also in the lateral directions both during the drying of the layers and also during the sintering. Because perforated sheets represent a rigid system during the heat treatment, the shrinking may cause cracking in the anode layer or a distortion of the composite made of perforated sheet and anode layer.

One object of certain embodiments of the present invention is to provide a remedial measure for the problems described, i.e., a solution is sought for how an anode functional layer in particular may be applied in a functionally secure way to a metallic support structure, having through openings for a gas, of a high-temperature fuel cell.

This object is achieved with a fine-pored intermediate structure made of nickel or a nickel alloy provided between the coarse-pored support structure and the functional layer facing toward it. Advantageous refinements are also provided herein, as well as a preferred production method.

A composite made of a (relatively) coarse-pored metallic support structure is suggested, preferably in the form of a perforated sheet or a perforated foil, but also in the form of woven or knitted fabric or a component produced by powder metallurgy, and a so-called intermediate structure made of nickel or a nickel alloy, which is fine-pored, and on which the corresponding functional layer may be applied almost flawlessly. This may be more or less a multicomponent intermediate structure, if an anode material, such as a Ni/YSZ mixture (=mixture made of nickel and yttrium-stabilized zirconium oxide) is infiltrated into this porous intermediate structure, which is initially only formed by nickel or a nickel alloy, i.e., introduced into its pores. In this case, the multicomponent intermediate structure may simultaneously fulfill the function of the fuel cell anode, so that the electrolyte layer (of the functional layers anode-electrolyte-cathode lying one on top of another) is then applied thereto as the functional layer; however, it is also possible that initially a further anode layer is applied to the intermediate structure already infiltrated with anode material. The essential objects of an SOFC anode, namely electrical conductivity on one hand and electrochemical activity on the other hand, are decoupled by a multicomponent structure of the intermediate layer. The first is provided by the nickel material and the latter by the infiltrated anode material, which is thus intimately bonded to the nickel material.

In a preferred embodiment, the fine-pored intermediate structure (still without infiltrated anode material) is formed by a mesh made of fine nickel wire having a mesh width in a magnitude of less than 80 μm; however, the use of nickel foams or other porous nickel structures is also possible. In addition to a pure nickel structure, the use of suitable nickel alloys (e.g., having chromium or molybdenum) is also possible, whose thermal expansion coefficient may be tailored better to that of the metallic support structure than that of pure nickel, and which possibly have better reoxidation stability.

According to a preferred production method for a fuel cell having a so-called “multicomponent” intermediate layer, in a first step, a fine-pored nickel structure, preferably the previously-mentioned net, is bonded to a coarse-pored metallic substrate (the support structure), the pore diameters of the nickel structure being significantly smaller than those of the metallic substrate. This bond between the intermediate structure and the metallic substrate is preferably produced by punctual or planar resistance welding, alternatively, sintering under load is also possible. In a second step, the meshes and/or pores of the nickel structure are infiltrated using a catalytically active anode material. According to the current prior art, mixtures made of nickel and a doped zirconium dioxide are best suitable for this purpose. The possibility also exists to introduce the anode material by a wet-chemical method or by laminating an anode green tape foil and performing sintering. Alternatively, the anode material may also be introduced into the composite made of metallic (coarse-pored) support structure and fine-pored nickel intermediate structure by thermal spraying methods. The anode material introduced into the nickel intermediate structure fulfills the object of electrochemical activity within the multicomponent intermediate structure, which may simultaneously be the anode functional layer, if the electrolyte layer is applied thereto and finally the cathode functional layer is applied thereon.

Other objects, advantages and novel features of the present invention will become apparent from the following detailed description of the invention when considered in conjunction with the accompanying drawings.

### BRIEF DESCRIPTION OF THE DRAWINGS

FIG. 1 is a photograph showing detail of a perforated sheet in accordance with one embodiment of the invention;

FIG. 2 is an enlarged microscopic image of a nickel mesh on the perforated sheet.

### DETAILED DESCRIPTION OF THE DRAWINGS

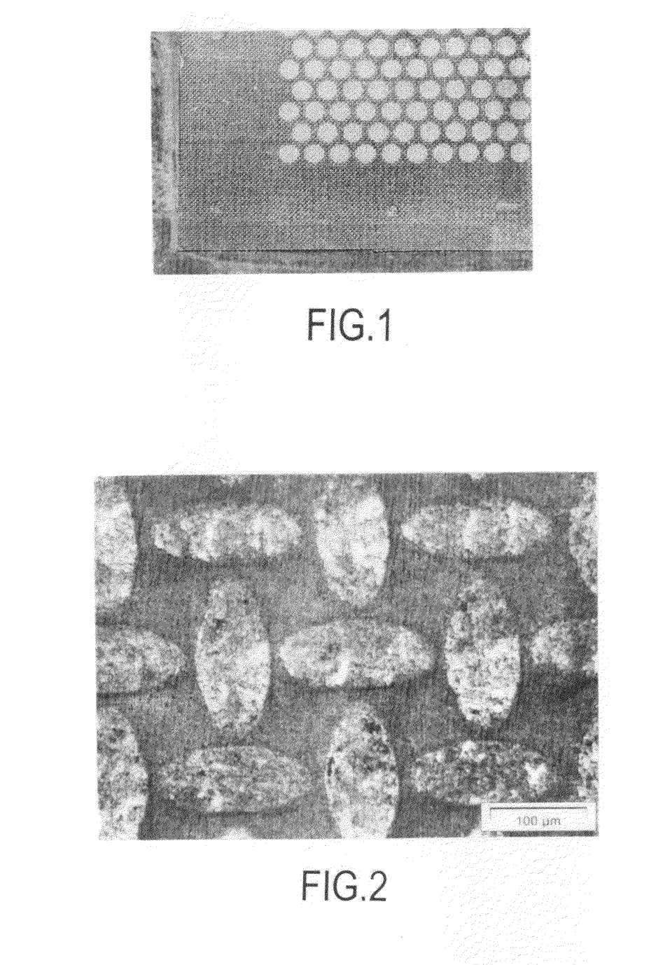

FIG. 1 shows a photo as a significantly enlarged view of a perforated sheet (as a support structure) on which a mesh is applied as a so-called intermediate structure. No anode material has yet infiltrated into this mesh, so that the holes of the perforated sheet, which have a diameter of a magnitude of 1 mm, may be recognized through the pores. FIG. 2 shows a still further enlarged microscopic image of a nickel mesh on the perforated sheet, the pores of the nickel mesh being filled with anode material. This anode material (NiO, 8YSZ) was squeegeed on in the form of a paste, which also contained a binder solution, and then sintered at temperatures less than 1250° C. under protective gas. Alternatively, however, a nickel net having a mesh width of 80 μm may be welded onto a coarse-pored support structure made of a wire fabric made of Crofer22APU (having a wire diameter of 100-300 μm and a mesh width of 100-300 μm). The coarse-pored support structure may also be a substrate produced by powder metallurgy, (for example, having a particle diameter of 100-300 μm and a pore size <400 μm).

This construction provides advantages in the service life of metal substrate-anode composites, fabrication technology, costs, and the function of the composite. In particular, the multicomponent intermediate structure (namely nickel structure and infiltrated anode material) allows the use of coarse-pored metallic support structures having a low surface/volume ratio, which has an advantageous results for their service life by limiting corrosion. Therefore, the coating of perforated sheets or other coarse-pored substrates having different hole and/or pore diameters is made possible by the applying a fine-pored nickel intermediate structure. The required components (perforated sheets, nickel meshes or foams) are commercially available and the joining of the nickel structure to a perforated sheet (“perforated sheet”) may be performed by industrially established methods, such as resistance welding. Both have positive effects on the production costs. By decoupling the anode functions of “electrical conductivity” (nickel structure) and “catalytic activity” (anode material), independent optimization is possible. Thus, the anode material may be sintered into the pores (or meshes) of the nickel structure at low temperatures, which is accompanied by low shrinkage of the anode material. A high porosity multicomponent functional layer may thus be achieved, without reducing the electrical conductivity. In this way, not only is good gas permeability provided, but also the reoxidation stability upon air influx on the anode side of an SOFC may be favored by high porosity.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A high-temperature fuel cell comprising:
a metallic support structure for solid oxide functional layers, said metallic support structure having through openings for a gas;
a porous intermediate structure made of nickel or a nickel alloy provided on the support structure; and
a functional layer provided on the intermediate structure.

2. The fuel cell of claim 1, wherein the intermediate structure is fine-pored relative to the support structure.

3. The fuel cell of claim 1, wherein the intermediate structure is a mesh having a mesh width of less than 80 μm.

4. The fuel cell of claim 1, wherein the support structure is a perforated sheet or a perforated film.

5. The fuel cell of claim 1, wherein the functional layer is provided on both the intermediate structure and the support structure.

6. The fuel cell of claim 1, wherein the functional layer comprises an anode material and said anode material is introduced into the porous intermediate structure.

7. The fuel cell of claim 6, wherein the anode material is a Ni-YSZ mixture.

8. The fuel cell of claim 1, wherein the functional layer comprises a first anode layer and a second anode layer provided on the first anode layer.

9. The fuel cell of claim 1, wherein the functional layer comprises an anode layer and an electrolyte layer is provided on the functional layer.

10. The fuel cell of claim 9, further comprising a cathode layer provided on the electrolyte layer.

11. A method for producing a fuel cell comprising the steps of:
welding a porous intermediate structure to a metal support structure; and
introducing catalytically active anode material into the pores of the intermediate structure.

12. The method of claim 11, wherein the intermediate structure is fine-pored relative to the support structure.

13. The method of claim 11, wherein the intermediate structure is a mesh having a mesh width of less than 80 μm.

14. The method of claim 11, further comprising the step of:
applying an electrolyte layer on the anode material.

15. The method of claim 14, further comprising the step of:
applying a cathode layer on the electrolyte layer.

16. The method of claim 11, where said catalytically active anode material is introduced into both the pores of the intermediate structure, and pores in the metal support structure.

17. The method of claim 11, wherein the anode material is a Ni-YSZ mixture.

18. The method of claim 11, further comprising applying an anode layer on the anode material already introduced into the pores of the intermediate structure.

19. A high-temperature fuel cell comprising:
a metallic support structure for solid oxide functional layers, said metallic support structure having through openings for a gas;
a porous intermediate structure made of nickel or a nickel alloy provided on the support structure;
a functional layer provided on the intermediate structure, wherein said functional layer comprises an anode material and said anode material is introduced into the intermediate structure;
an electrolyte layer provided on the functional layer;
a cathode layer provided on the electrolyte layer.

20. The fuel cell of claim 19, wherein said functional layer further comprises an anode layer applied to the anode material.
